(19) United States
(12) Patent Application Publication
(10) Pub. No.: US 2026/0271894 A1
(43) Pub. Date: Sep. 17, 2026

(54) WAVE GENERATOR FOR AN AQUARIUM AND RELATED METHODS

(71) Applicant: Greg Esmond, Frisco, TX (US)

(72) Inventor: Greg Esmond, Frisco, TX (US)

(21) Appl. No.: 19/557,271

(22) Filed: Mar. 5, 2026

Related U.S. Application Data
(60) Provisional application No. 63/771,048, filed on Mar. 13, 2025.

(51) Int. Cl. A01K 63/00

(52) U.S. Cl. CPC A01K 63/006

(57) ABSTRACT

A wave generator system including a transducer. The transducer is configured to generate an airwave at a first harmonic frequency to form a corresponding water wave within an enclosed body of water.

### CROSS-REFERENCE TO RELATED APPLICATION

This application is a regular utility application of U.S. Provisional Application No. 63/771,048, filed Mar. 13, 2025, the contents of which are expressly incorporated herein by reference.

### FIELD OF ART

The present disclosure is generally directed to aquariums, with specific discussions on apparatus and system for generating water waves within an aquarium, such as for marine and reef aquariums, and related methods thereof.

### BACKGROUND

An aquarium is a particular type of vivarium which generally consists of a transparent and open-air enclosure that is filled with fresh or salt water to hold and display a water habitat for aquatic life, such as fish, coral, plants, or other aquatic organisms. To maintain a healthy environment for the inhabitants of the aquarium, the owner or caretaker must carefully monitor the various parameters of the water within the enclosure, including the water chemistry, filtration, circulation, and temperature. To assist in managing such a healthy environment, some aquariums include sensors, such as a thermometer, a pH sensor, etc., a heater, lighting fixtures, an air pump to aerate the water, water filters, a mister, or an automatic fish feeder. Some aquariums include water jets or pumps to circulate the flow of water within the enclosure. Such water jets typically include an impeller driven by an electric motor for creating a jet stream that circulates the water within the enclosure. This circulation of water within the enclosure is both aesthetically pleasing and ecologically beneficial to circulate oxygen and help the filter intake and process any waste within the enclosure. However, water jets can be costly to operate and maintain. Furthermore, water jets may introduce a substantial amount of noise pollution, which may negatively impact the inhabitants of the aquarium, such as negatively affecting the feeding habits, behavior, and overall health of the inhabitants.

### SUMMARY

Broadly speaking, aspects of the invention are directed to apparatuses, systems, and methods for generating water waves inside of an enclosed body of water, such as an aquarium. The wave generator system, which can have one or more components, may generate an aesthetically pleasing wave pattern in the aquarium by introducing one or more harmonic frequencies emitted by a transducer. In one embodiment, the wave generator system may determine one or more harmonic frequencies that are specifically keyed to a particular aquarium. Thereafter, the wave generator system may determine a cycle of alternating or combined harmonic frequencies for creating a corresponding wave pattern in the aquarium.

Aspects of the invention include a wave generator system that includes a transducer configured to generate an airwave at a first harmonic frequency to form a corresponding water wave within an enclosed body of water. In some examples, the transducer can embody a diaphragm speaker, wherein movement of the diaphragm can move air to then move water to generate a water wave.

Aspects of the invention include a wave generator system that includes a transducer configured to generate an airwave at a first harmonic frequency and a wave chamber fluidly coupled to the transducer. The wave chamber is configured to receive the airwave from the transducer and generate a water wave in an enclosed body of water.

Aspects of the invention also include an aquarium that includes an enclosure which is configured to hold water therein. The aquarium also includes a transducer located outside of the enclosure and configured to generate an airwave at a first harmonic frequency, and a wave chamber fluidly coupled to the transducer. The wave chamber is located within and connected to the enclosure. The wave chamber is configured to generate a water wave in the enclosure based at least in part upon the first harmonic frequency.

Aspects of the invention also include a method for generating water waves. The method includes determining one or more harmonic frequencies of an enclosed body of water. The method also includes generating, by a transducer, an airwave based on the one or more harmonic frequencies. The method also includes generating, by a wave chamber fluidly coupled to the transducer, a water wave in the enclosed body of water, based at least in part upon the airwave.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 illustrates a schematic and front view of an exemplary embodiment of a wave generator system that includes a transducer and a wave chamber for generating a water wave inside of an aquarium.

FIG. 2 illustrates a schematic and side view of the wave generator system of FIG. 1.

FIG. 3 illustrates an elevated side perspective view of the wave generator system of FIG. 1.

FIG. 4 illustrates a side perspective view of the wave chamber of the wave generator system of FIG. 1.

FIG. 5 illustrates a schematic view of another exemplary embodiment of a wave generator system which includes one or more sensors for sensing the wave inside the aquarium.

FIG. 6 illustrates a schematic view of another exemplary embodiment of a wave generator system which includes two wave chambers.

FIGS. 7A-7C illustrate graphical representation of exemplary wave patterns corresponding to respective harmonic frequencies.

FIGS. 7D-7E illustrate transducer output across time.

FIG. 8 illustrates a flowchart of a method for generating water waves within an aquarium.

### DETAILED DESCRIPTION

The detailed description set forth below in connection with the appended drawings is intended as a description of the presently preferred embodiments of wave generator systems, apparatuses, and methods for generating aesthetically pleasing waves inside a body of water, including but not limited to an aquarium, a water tank, a pool, etc., in accordance with aspects of the present devices, systems, and methods, and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

As used herein, the term fundamental or base frequency generally refers to a frequency at which a standing wave is formed in an enclosed body of water. The term standing wave or wave pattern may refer to a resulting wave, or multiple waves, created by the interference of two opposed and identical wave forms propagating through the water, in which the two waves have the same frequency and amplitude. The base frequency may be referred to as a first harmonic frequency, or first harmonic for short. The second, third, fourth, etc., harmonic frequencies may refer to higher order, multiples of the first harmonic frequency. The term wave pattern may refer to any desired pattern of one or more waves. The term enclosed body of water may refer to a body of water that is confined within a space or an enclosure.

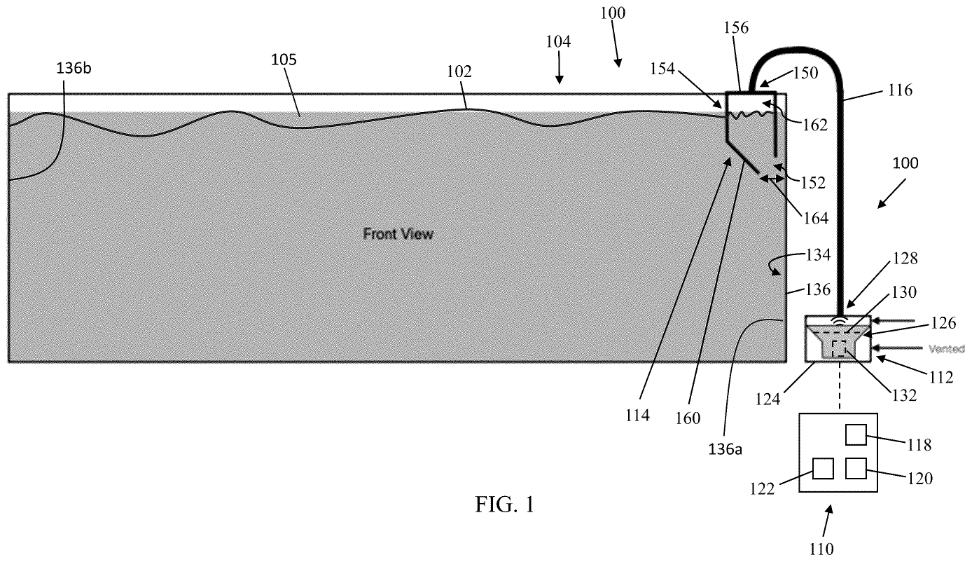

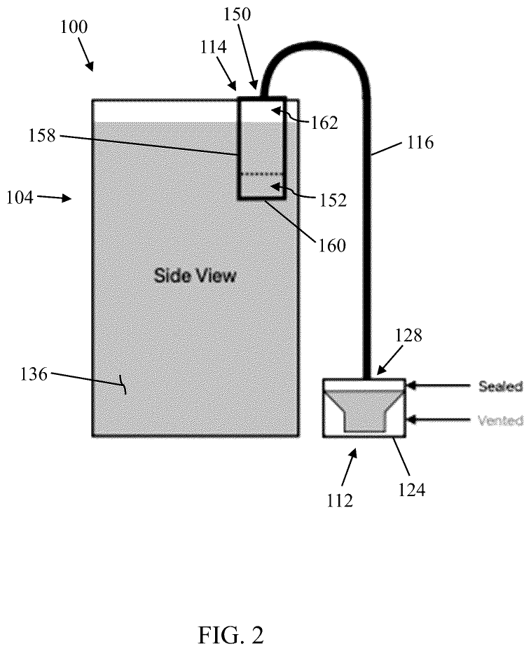

Referring initially to FIGS. 1-4, there is shown an exemplary embodiment of a wave generator system 100 for generating a wave pattern 102 (FIG. 1), consisting of one or more water waves, inside of an enclosed body of water 105. The enclosed body of water 105 may comprise an aquarium, or other water-based vivarium, a tank, a container, or a pool 104, which is filled with water. In one embodiment, as shown, the enclosed body of water 105 is enclosed by an aquarium 104. The aquarium 104 can have any number of known constructions, shapes, and sizes. The aquarium 104 may hold and display aquatic life therein, such as fish, reptiles, coral, or plants, however in some embodiments the aquarium 104 (or other tank) may not have aquatic life therein. The aquarium 104 may be configured as a fresh or salt water aquarium. The wave generator system 100 generally includes a system controller 110, a transducer 112 configured to generate airwaves at one or more harmonic frequencies, and a wave chamber 114 to be disposed within the aquarium 104 and fluidly coupled to the transducer 112 via an air tube 116. At least part of the wave chamber 114 should be disposed below the water surface, as further discussed below. The transducer 112 is configured to generate one or more airwaves that are fed into the wave chamber 114 via the air tube 116. The wave chamber 114 may then receive and convert the airwaves into water waves that are directed into the aquarium 104. The water waves from the wave chamber 114 may propagate throughout the aquarium 104 and create a desired wave pattern 102 that corresponds to the one or more harmonic frequencies emitted by the transducer 112, giving the aquarium a lifelike wave motion similar to that of underwater wildlife. Thereby, the wave generator system 100 may create and cycle between multiple differing wave patterns 102 that are aesthetically pleasing and beneficial for circulating the water within the aquarium 104. In one embodiment, the wave generator system 100 may be an independent unit that can be removably attached to an existing, prefabricated aquarium 104. In another embodiment, the wave generator system 100 may be built-in or integrally formed as part of the aquarium 104.

The system controller 110 is operably coupled to the transducer 112 for controlling the operation thereof. In particular, the system controller 110 is configured to provide an electrical signal to the transducer 112, which converts the electrical signal into the airwaves which are supplied to the wave chamber 114. In one embodiment, the electrical signal may comprise a sine wave (or sinusoid) at a constant amplitude and period. However, in another embodiment, the electrical signal may comprise another waveform, such as a square wave or other non-sinusoidal periodic waveform. In one embodiment, the system controller 110 may comprise at least one hardware processor 118, at least one memory 120, and a display screen 122 or other human machine interface (HMI) or user interface (UI). Each memory 120 (e.g., hard drive, solid state drive, RAM, flash, ROM, etc.) can have stored thereon instructions that when executed by the at least one hardware processor 118 cause the at least one hardware processor 118 to perform several tasks, including access data files, analyze data files, perform analysis of the data files, and provide outputs indicative of characteristics or parameters represented by the data files. The software instructions preferably configure the system controller 110 to execute the functionality as disclosed. In one embodiment, the system controller 110 may comprise a commercially available controller, such as a Raspberry Pi® with one or more auxiliary circuit boards connected thereto for controlling the various operations of the wave generator system 100.

The transducer 112 is configured to generate airwaves based on the electrical signals provided by the system controller 110. In an example, the transducer embodies a speaker with a diaphragm that is held by a suspension and is configured to move in a way that does not produce sound waves in air, but still physically vibrates. The movement of the diaphragm, which displaces air in an oscillation, is used to move water and generate the wave form described herein. The transducer 112 can be operably connected to the system controller 110 via a wired or wireless connection. The transducer 112 is also fluidly coupled to the wave chamber 114 via the air tube 116. In one embodiment, the transducer 112 may comprise a housing 124 and a speaker 126 disposed within the housing 124. In one embodiment, the housing 124 may comprise a top wall, a bottom wall, and sidewalls (unnumbered) extending between the top wall and the bottom wall. In one embodiment, the housing 124 may comprise an annular housing. The top wall (or other wall) of the housing 124 may include a sealed outlet port 128 that mounts or otherwise receives the air tube 116. The housing 124 may be internally partitioned such that the housing 124 includes a vented chamber or portion with an air inlet or vent, to let air therethrough, and a sealed air chamber or portion, located above the speaker, which is fluidly coupled to the outlet port 128 of the transducer 112. In one embodiment, the speaker 126 may comprise an ultrasonic or subsonic speaker. In an example, as shown in phantom in FIG. 1, the transducer 112 may comprise a diaphragm speaker 126 which includes a diaphragm 130 oscillated by an electric motor 132 operably coupled thereto. Hence, in one embodiment, the voltage fluctuations in the electric signal may cause the electric motor 132 to oscillate (or vibrate) the diaphragm 130 to generate the airwaves.

In detail, the diaphragm 130 generates moving bands of compressed fluid (at a higher pressure) and expanded fluid (at a lower pressure) that propagate through the air tube 116 and into the wave chamber 114. In one embodiment, such airwaves may be inaudible to humans and the animal life within the aquarium 104. After generation, the airwaves may pass through the outlet port 128 of the housing 124, through the air tube 116, and into the wave chamber 114. The transducer 112 may have the ability to vary the characteristics of the airwaves, such as the wave form or pattern, strength or volume, the amplitude, and the frequency of the airwaves, ranging from approximately less than 3 Hz. In one embodiment, the transducer 112 may comprise a piezoelectric transducer of either a ceramic crystalline type, such as a berlinite, quartz, or tourmaline crystal, or a film organic material type. In one embodiment, the transducer 112 may be waterproof.

In operation, the transducer 112 can generate multiple harmonic frequencies and apply these frequencies in a variety of differing cycles. Therein, the transducer 112 can emit a particular harmonic frequency (in isolation) in a given time interval or period, alternate multiple differing harmonic frequencies in respective time periods, and/or simultaneously emit multiple differing harmonic frequencies at the same time for a given time period. In one embodiment, the transducer 112 is configured to generate only one harmonic frequency, which individually forms the wave in the aquarium 104.

In one embodiment, the transducer 112 is configured to generate and cycle multiple harmonic frequencies, including a first harmonic frequency, a second harmonic frequency, and a third harmonic frequency, which collectively form the wave(s) of the wave pattern 102 in the aquarium 104. For very large aquariums, such as 500 gallons or higher, higher harmonics may be utilized to visibly perceive the wave patterns, in the order of six or higher, such as eight or higher, or ten or higher. In one embodiment, the first, the second, and the third harmonic frequency are generated by the transducer 112 in an alternating cycle such that the transducer 112 alternates between the first harmonic frequency, the second harmonic frequency, and the third harmonic frequency, wherein each harmonic frequency is emitted for a respective time period (e.g., identical time periods or unique and differing time periods). In one embodiment, the first harmonic frequency, the second harmonic frequency, and the third harmonic frequency are generated by the transducer 112 in a combined cycle such that the transducer 112 generates and emits the first harmonic frequency, the second harmonic frequency, and the third harmonic frequency at the same time, as discussed in more detail herein.

The output frequency of the transducer 112 can vary or be adjusted by using a function generator, which can have an adjustable frequency dial to vary the airwave frequency. The output frequency can also vary by using a microcontroller, such as a pulse width modulator or a digital-to-analog converter. The output frequency can also vary by using an analog oscillator circuit, such as a resistor-capacitor (RC) oscillator, an inductor-capacitor (LC) circuit, or a voltage-controlled oscillator (VCD). Another method of varying the output frequency is by using a synthesizer or audio processor. These various devices and equivalent devices for varying the output frequency can generically be referred to as the noted controller.

The wave chamber 114 is configured to generate water waves to form the wave pattern 102 in the aquarium 104, based at least in part upon the one or more airwaves operating at the output frequencies of the diaphragm 130, or of the transducer 112. The wave chamber 114 may be connected to or supported by the aquarium 104, via support mechanism, such as a waterproof epoxy, Velcro®, brackets, magnets, and/or fasteners. The wave chamber 114 may reside entirely within the bounds of the aquarium 104 or extend outside of the bounds of the aquarium 104 such that a portion of the wave chamber 114 resides above or outside of the bounds of the aquarium 104. In one embodiment, the wave chamber 114 can be connected to an interior surface 134 of a wall 136 of the aquarium 104 in its operational position. In an example, a top surface of the wave chamber 114 is located above the waterline inside the aquarium such that an air space is present inside the wave chamber 114, defined by the waterline and the inside interior top surface of the wave chamber 114. Air entering the wave chamber through the air tube 116 should be exposed to the air space inside the wave chamber, as further discussed below. In one embodiment, the wave chamber 114 is connected to the interior surface 134 of a lateral sidewall 136 of a rectangular aquarium 104. In an example, the wave chamber 114 may be attached to the sidewall 136, at a corner between two adjoining walls of the aquarium, such as with a bracket or brace.

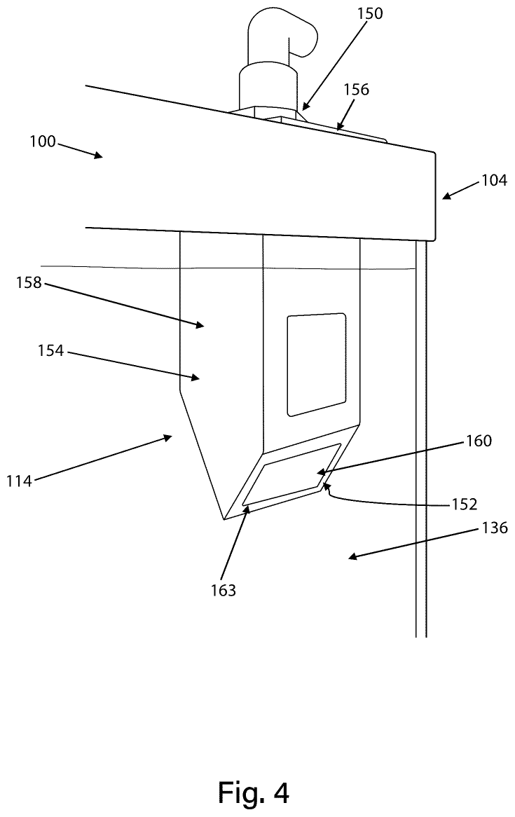

The wave chamber 114 generally comprises an inlet 150, which is fluidly and sealably connected to the transducer 112 and which receives the airwaves, and an outlet 152. In an example, the inlet and the outlet are located at opposite ends of housing. In one embodiment, the inlet 150 of the wave chamber 114 is configured to be located above a waterline, i.e., surface of the wave(s) of the wave pattern 102, of the water within the aquarium 104, and the outlet 152 is configured to be located underneath the waterline of the water within the aquarium 104. In one embodiment, the wave chamber 114 comprises a shell body 154 including a top wall 156, a plurality of sidewalls 158 extending from the top wall 156, and a bottom wall 160 connected to at least one of the side walls 158 (FIG. 4). In an example, the bottom wall 160 is slanted or angled relative to the front sidewall adjacent the outlet 152 and has a bottom-most edge 163. In other examples, the wave chamber 114 can have a housing that is sized and shaped differently, for example having a narrow, long, and/or thin cuboid shape or a square shape.

The shell body 154 defines an interior chamber or space 162 (FIG. 1). In one embodiment, the top wall 156 includes the inlet 150 therein. In one embodiment, the inlet 150 is in the form an inlet aperture or inlet port 150 extending through the top wall 156 of the body 154. In one embodiment, the bottom wall 160 and/or sidewall 158 (which faces the vertical sidewall 136 of the tank) may include the outlet 152 therein. In an example, the outlet 152 can be in the form of an outlet aperture 152 extending through the bottom wall 160 (and/or sidewall 158). In some examples, the different sidewalls 158 can have different dimensions so that the outlet 152 is formed by the dimensional differences of the sidewalls 158 and the bottom wall 160. In still yet other examples, the shell body 154 can have a generally rectilinear shaped body with a cut-out forming the outlet 152.

In one embodiment, the bottom wall 160 may be a ledged or overhanging bottom wall that is connected to a sidewall 158 at one section thereof but not completely connected to the sidewalls 158 about its periphery, and thus the outlet 152 may be defined by a gap between an end of the ledged bottom wall 160 and the juxtaposed sidewall 158, such that the water waves are directed downwardly and toward the vertical sidewall 136 of the aquarium 104. In one embodiment, the bottom wall 160 may comprise a pair of angled bottom walls 160, extending downwardly from the sidewalls 158 and terminating at an apex (unnumbered), and therein the outlet 152 may be defined by a cutout, e.g., a rectangular cutout, in one of the angled bottom walls 160 (see e.g., FIG. 4). Due to the angle of the bottom wall 160, the outlet 152 within the bottom wall 160 can be angled relative to and spaced apart at a distance 164 from the vertical wall of the aquarium 104, when the wave chamber 114 is connected to the vertical wall 136 of the aquarium 104 in the operational position thereof. In some examples, the wave chamber 114 is formed by gluing polymeric panels having the disclosed shapes to form the disclosed housing structure. In other examples, the wave chamber is molded or at least partially molded and the multi-pieces are bonded together.

In one embodiment, the wave chamber 114 may be configured to direct the water waves in a particular direction within the aquarium 104. For instance, in one embodiment, the shape of the body 154 of the wave chamber 114 and/or the shape of the outlet 152 (or baffles thereof, if equipped) may direct the water waves toward the vertical wall 136 of the aquarium 104 to which the wave chamber 114 is attached. If the wave chamber 114 is instead attached to the lengthwise sidewall, then the outlet 152 is arranged to direct water waves towards the vertical end wall 136a that is closest to the wave chamber. In an example, the outlet 152 may generally face (or be directed toward) the vertical end wall 136a of the aquarium 104, which mounts the wave chamber 114. Additionally, the angle of the bottom wall 160 of the wave chamber 114 may direct the flow of fluid downwardly and out through the outlet 152 such that the water waves exiting the wave chamber 114 are directed downwardly and toward the vertical end wall 136 of the aquarium 104 to which the wave chamber 114 is attached. Thereafter, upon exiting the wave chamber 114, the water waves may contact and rebound off the vertical wall 136 (e.g., right sidewall 136a in FIG. 1), propagate throughout the aquarium 104 in a first direction (away from the wave chamber 114), rebound against the opposite vertical wall 136 (e.g., left sidewall 136b in FIG. 1), and propagate back through the aquarium 104 in a second, opposite direction (toward the wave chamber 114). At a harmonic frequency, the propagating wave forms may interfere with one another accordingly generate the desired wave pattern 102. In an alternative embodiment, the wave chamber 114 can be connected to a top section or a cover of the aquarium 104. Thus, the wave generator system 100 in accordance with aspects of the invention is configured to generate waves that travel along the lengthwise direction of the aquarium 104 and bouncing off of the two end vertical walls 136a, 136b.

In one embodiment, the wave chamber 114 is configured to be at least partially filled with water. For example, in one embodiment, the wave chamber 114 is substantially submerged within the aquarium 104 such that water from the aquarium 104 enters the outlet 152 and fills a section of the interior space 162 of the wave chamber 114. In detail, because the wave chamber 114 is at least partially filled with water, the wave chamber 114 can generate an initial water wave, in the water located within the wave chamber 114, and thereafter expel the initial water wave toward the vertical wall 136 of the aquarium 104 to generate the water wave within the aquarium 104. In an example, approximately three-quarters of the interior chamber 162, i.e., 75% of the volume of the interior chamber 162, can be filled with water, plus or minus 25% of the volume of the interior chamber 162. The air-filled or unfilled section (i.e., the air space above the body water inside the wave chamber) of the interior chamber 162 is fluidly coupled to the air tube 116 and the sealed air chamber of the housing 124 of the transducer 112, creating a sealed and pressure-controlled passageway between the transducer 112 and the water within the interior space 162 of the wave chamber 114. Thereby, minimal to no pressure loss (and therefor energy loss) may occur between the transducer 112 and the wave chamber 114, thus maximizing the impact of the airwaves to create the strongest water waves possible within the wave chamber 114.

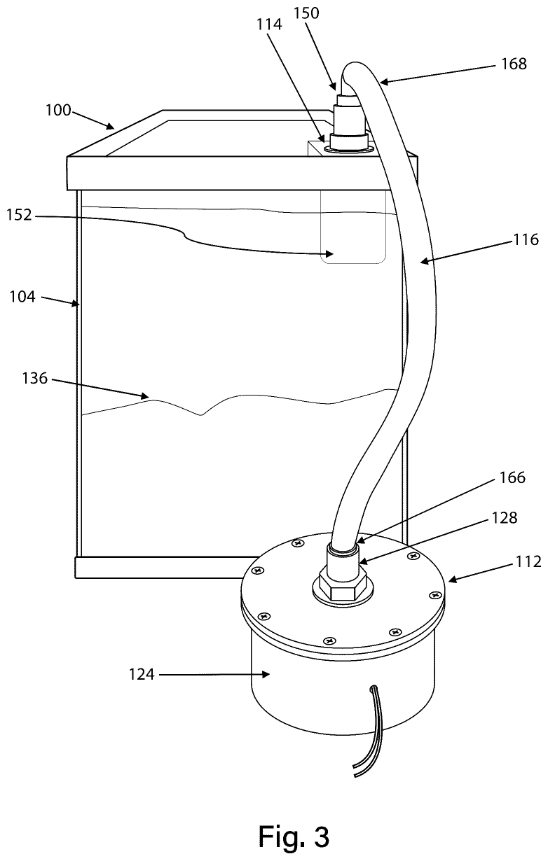

The air tube 116 sealably couples the transducer 112 and the wave chamber 114 together with one another. In an example, a first end 166 of the air tube 116 can be connected to the outlet port 128 of the transducer 112, and a second opposite end 168 of the air tube 116 can be connected to the inlet 150 of the wave chamber 114 (FIG. 3). The air tube 116 may comprise any desired flexible or nonflexible tube, channel, or hose. The air tube 116 may be composed of polyurethane, polyethylene, polyvinyl chloride (PVC), nylon, silicone, and/or neoprene rubber. In one embodiment, the air tube 116 may comprise a reinforced and plastic flexible hose.

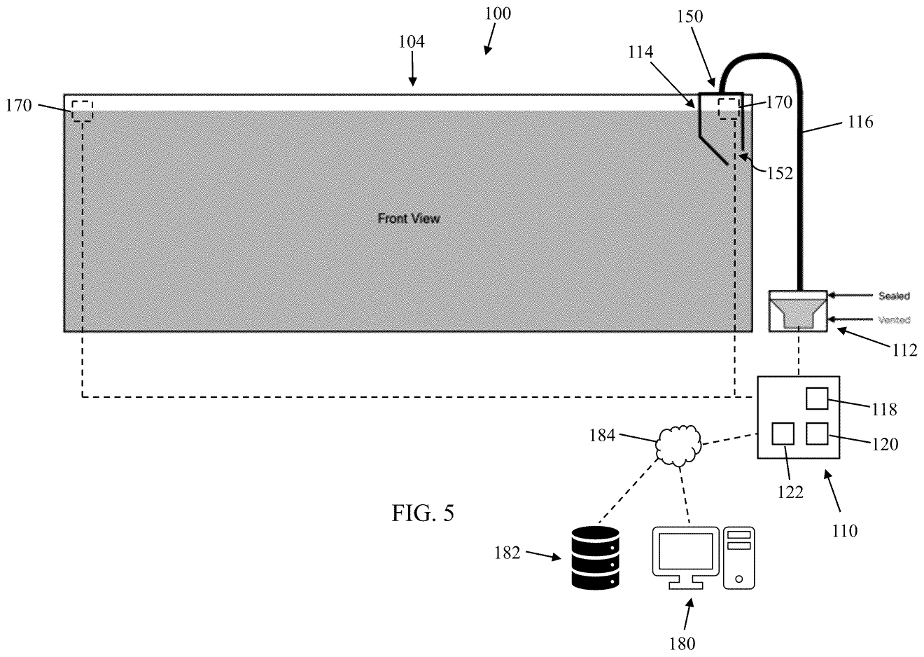

Referring now to FIG. 5, there is shown another embodiment of a wave generator system 100 which can be substantially similar to the wave generator system 100 as discussed above with respect to FIG. 1 with a few modifications. In the present embodiment, one or more sensors 170 can be incorporated to provide feedback to the controller 110. The one or more sensors 170 may be configured to sense various characteristics of the aquarium 104, including the dimensions of the aquarium 104 and the water therein, as discussed further below. The system controller 110 of the wave generator system 100 may also be operably connected to a user device 180 and a remote database 182 via a network 184.

In one embodiment, the one or more sensors 170 may be configured for detecting a size, shape, and/or model of the aquarium 104. For instance, the sensor 170 may measure a distance (e.g., length) between opposed vertical walls of the aquarium 104, and thereafter provide the measured distance to the system controller 110 for subsequent determination of harmonic frequencies associated with the size of the aquarium 104, such as the length of the aquarium between the two vertical end walls. In one embodiment, the wave generator system 100 may include one or more sensors 170 configured for monitoring the water within the aquarium 104 and/or within the wave chamber 114 to determine one or more characteristics of the water waves therein. The one or more characteristics of the water wave may include, but not be limited to, a wave pattern, a position of the water wave, an amplitude, a wavelength (length of the wave), a number and/or position of crests of the water wave, a number and/or position of troughs of the water wave, and/or a cycle of the water wave (e.g., a complete repetition of the wave's motion across the aquarium 104). The one or more sensors 170 may be located within, on top of, or next to the aquarium 104. In another example, one sensor 170 can be mounted on a vertical sidewall of the aquarium 104, adjacent to a top end thereof. In another example, one sensor 170 may be positioned on or within the wave chamber 114 for sensing the water within the wave chamber 114. Each sensor 170 may comprise an optical sensor, a light sensor, and/or an infrared sensor. In another embodiment, the wave generator system 100 may comprise an atmospheric or water pressure sensor, located within the air tube 116, the wave chamber 114, or the aquarium 104. Each sensor 170 can be operably connected to the system controller 110 via a wired or wireless connection.

The user device 180 may comprise a desktop computer, a laptop computer, a smartphone, a tablet computer, a wearable computer, a server, interfaces, databases, agents, engines, modules, a virtual machine being executed by a physical computing device, etc. The remote database 182 may comprise one or more memories for storing data related to various aquariums, aquatic life, user data, harmonic frequencies, etc. The remote database 182 may be incorporated as part of a wave generator server. Alternatively, in one embodiment, the remote database 182 may be a third party database which includes known dimensions of various aquariums 104.

The network 184 can be any suitable communication network or combination of communication networks configured to allow the system controller 110, the user device 180, and the database 182, to communicate with one another. For example, the communication network can include a Wi-Fi network (which can include one or more wireless routers, one or more switches, etc.), a peer-to-peer network (e.g., a Bluetooth network), a cellular network (e.g., a 4G network, a 4G network etc., complying with any suitable standard, such as CDMA, GSM, LTE, LTE Advanced, WiMAX, etc.), or a wired network, such as an ethernet cable. In some embodiments, the communication network 184 can be a local area network, a wide area network, a public network (e.g., the Internet), a private or semi-private network (e.g., a corporate intranet), any other suitable type of network, or any suitable combination of networks. Communications links can be any suitable communications link or combination of communications links, such as wired links, fiber optic links, Wi-Fi links, Bluetooth links, cellular links, etc. The communication network 184 can include any suitable hardware, firmware, and/or software for establishing communication. For example, the communication network 184 can include communication systems that comprise one or more transceivers, one or more communication chips and/or chip sets, etc. In a more particular example, communications systems can include hardware, firmware and/or software that can be used to establish a Wi-Fi connection, a Bluetooth connection, a cellular connection, an Ethernet connection, etc.

In operation, the system controller 110 may prompt the user device 180 to allow the user to select a desired wave pattern or sequence of wave patterns. The system controller 110 may cause the user device 180 to display a graphical user interface wherein the user may input data. In an example, the user may select a general category, such as a light, medium, or heavy wave effect corresponding to respective wave patterns, adjust a slider or spectrum icon which has indexed positions indictive of respective wave patterns, select a specific harmonic frequency or select a combination of harmonic frequencies. Additionally, the user may input the make, model, or dimensions of the aquarium 104. The user may also input additional information pertaining to the water and/or aquatic life therein, such as whether the water is fresh water or salt water and a number and type of fish, plant life, coral, etc. Thereafter, the system controller 110 may take the user inputted data into account and generate the wave pattern within the aquarium 104 responsive to the user inputted data. In one embodiment, the system controller 110 may access and retrieve data from the remote database 182. For example, in one embodiment, the system controller 110 may retrieve the dimensions of a particular aquarium 104 (as determined by the system controller 110 via the sensors 170 or as received via inputted data) and/or the various harmonic frequencies that correspond to the particular aquarium 104.

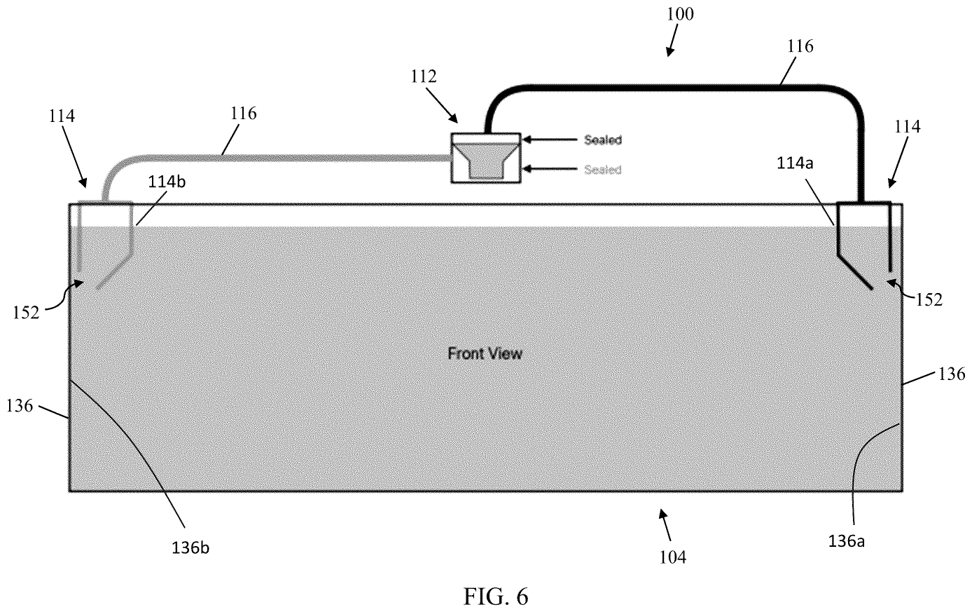

Referring now to FIG. 6, there is shown another embodiment of a wave generator system 100 which includes two or more wave chambers 114 fluidly coupled to the transducer 112. In one embodiment, as shown, a first wave chamber 114a is connected to a first wall 136a (e.g., the right vertical sidewall) of the aquarium 104 and a second wave chamber 114b is connected to a second vertical wall 136b (e.g., the left vertical sidewall) of the aquarium 104, opposite the first vertical wall of the aquarium 104. Each wave chamber 114a, 114b can be connected to the same transducer 112 such that the wave chambers 114a, 114b introduce and create identical wave patterns in the aquarium 104. The dual wave chamber 114 configuration, with opposed wave chambers 114, may generate stronger odd harmonic frequencies (e.g., the first, third, fifth, etc.) in comparison to a single wave chamber 114 configuration. In one embodiment, the two or more wave chambers 114 may each be substantially identical to one another. In alternative embodiment, the wave generator system 100 may include two or more transducers 112 that are respectively connected to the two or more wave chambers 114.

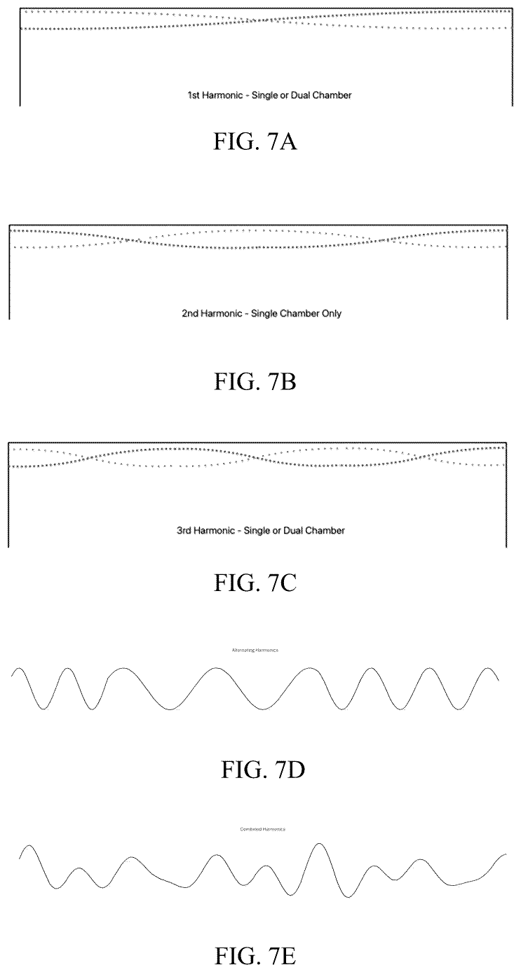

FIGS. 7A-7C illustrate exemplary wave patterns corresponding to respective harmonic frequencies. FIG. 7A illustrates a first wave pattern, within the aquarium 104, which corresponds to the first harmonic frequency (keyed to a specific aquarium 104). The first wave pattern may be generated using a single or dual wave chamber 114 configuration. FIG. 7B illustrates a second wave pattern which corresponds to the second harmonic frequency. In one embodiment, the second wave pattern is only creatable by a single wave chamber configuration. FIG. 7C illustrates a third wave pattern which corresponds to the third harmonic frequency. The third wave pattern may be generated using a single or dual wave chamber configuration.

FIG. 7D illustrates an alternating or sequential transducer signal pattern which corresponds to an alternating cycle of the first, second, and third harmonic frequencies, wherein each of the harmonic frequencies are emitted for a preset time period in a predetermined sequence. FIG. 7E illustrates a combi ed transducer signal pattern which corresponds to a combination of the first, second, and third harmonic frequencies, emitted simultaneously or as a summation of all three harmonic values. The wave generator 100 can also be operated to generate a multi-harmonic wave by generating discrete harmonic frequencies while a standing wave from a different harmonic is still present in the aquarium. In other words, before a standing wave dissipates, a new wave with a different harmonic can be generate to interact with the standing wave to generate a multi-harmonic wave in the aquarium.

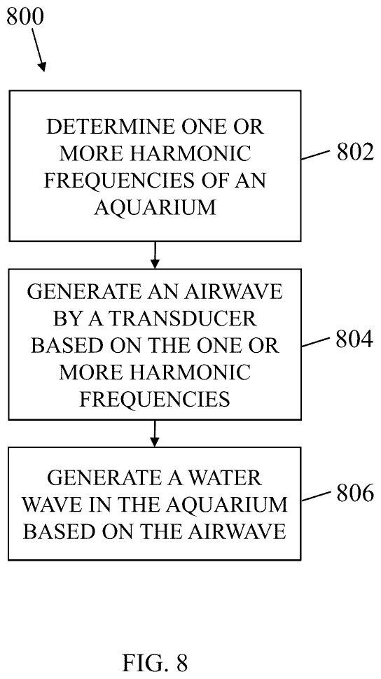

Referring now to FIG. 8, there is shown an exemplary method 800 for generating a water wave inside of an aquarium 104. At step 802, the method can include determining one or more harmonic frequencies of the aquarium 104, as discussed below in more detail. At step 804, the transducer 112 can generate airwaves based on the one or more harmonic frequencies. After exiting the transducer 112, the airwave will travel through the air tube 116 and into the wave chamber 114. At step 806, a water wave can be generated in the aquarium 104 based on the one or more harmonic frequencies and on the airwaves. For example, in one embodiment, the wave chamber 114 can receive the airwave from the air tube 116 and thereafter generate an initial water wave inside the wave chamber 114, similar to blowing air at the water surface at a selected frequency to create surface displacement. The initial water wave may then be forced out of the outlet of the wave chamber 114, via air pressure, and be directed toward a vertical wall of the aquarium 104, which thereby moves the water within the aquarium 104, creating a standing wave in accordance to the harmonic frequency or harmonic frequencies emitted by the transducer 112.

In one embodiment, the step of determining the one or more harmonic frequencies can be performed manually by an operator and/or automatically via the system controller 110 and sensor(s). In an example, the operator may manually determine one or more harmonic frequencies via setting an initial frequency and adjusting the frequency upon visually inspecting the resulting motion of the water waves in the aquarium 104. For instance, the operator may set an initial frequency of 0.5 Hz, corresponding to an initial period (such as one sound wave or air pressure, i.e., one oscillation or flex of the diaphragm of the transducer 112, every two seconds) and thereafter increase the frequency, by decreasing the period, i.e., decreasing the oscillations of the diaphragm by decreasing the speed of the motor, until a standing water wave becomes present, thus indicating a base resonant frequency (or resonant period) of the aquarium 104. Once the base resonant frequency, i.e., the base or fundamental harmonic frequency which is also the first harmonic frequency, is determined, the operator and/or system controller 110 may calculate and/or visually identify one or more harmonic frequencies from the base resonant frequency (i.e., the first harmonic frequency).

The system controller 110 may automatically determine the one or more resonant frequencies by data retrieval, calculation, and/or sensed feedback from the sensors 170. In one embodiment, the system controller 110 may retrieve known harmonic frequencies for a particular aquarium 104 via accessing the remote database. In one embodiment, the system controller 110 may determine the base harmonic frequency via sensing the dimensions of the aquarium 104 with the sensors 170, and thereafter calculate the base harmonic frequency (and any desired harmonic frequencies therefrom) as a function of the sensed dimensions of the aquarium 104. In an example, the system controller 110 may automatically determine one or more resonant frequencies by sensing a size and shape of the aquarium 104 via the sensors, and thereafter calculating the base resonant frequency as a function of the length of the aquarium 104 (or distance between opposite walls of the aquarium 104). In one embodiment, the system controller 110 may determine the base harmonic frequency based on information entered by a user via a user interface. In one embodiment, the system controller 110 may determine the base harmonic frequency in a troubleshooting procedure via emitting a preset frequency, monitoring the water for a desired standing wave (e.g., via identifying crests and/or troughs via the sensors 170), and adjusting the frequency emitted from the transducer 112 until the desired standing wave is achieved. Thus, in one embodiment, the method 200 may further include monitoring, by the sensor(s) 170, the water wave within the aquarium 104 to sense one or more wave characteristics of the water wave, and thereafter adjusting the airwave generated by the transducer 112, based upon the sensed one or more wave characteristics to achieve a desired wave pattern in the aquarium 104. Thereby, the operator and/or the system controller 110 can initially determine the desired harmonic frequencies for the aquarium 104 and continually monitor the wave pattern in the aquarium 104. In still other examples, a user can simply turn on the controller to generate a first frequency, which can be any random frequency. The user then observes the water waves moving back and for the between the two vertical end walls. The user can then manually adjust the frequency until a desired standing wave is obtained, which can be any discrete harmonics or a combination of harmonics.

In one embodiment, the method 200 may further include an additional step of cycling one or more harmonic frequencies to create a corresponding wave pattern in the aquarium 104. For example, the system controller 110 may individually emit one harmonic frequency at a time for a preset duration of time (e.g., 10 seconds each time interval). If multiple harmonic frequencies are used, the system controller 110 may determine a sequential order of the harmonic frequencies (e.g., looping the first, second, and third harmonic frequencies in numerical order). When alternating between the harmonic frequencies, the transition from one to the next may occur when the subsequent wave value crosses the current wave value, which may also help reduce motor noise due to eliminating an abrupt transition. Alternating the harmonic frequencies in sequence may not be perceptible to the human eye because the wave motion takes many cycles to build and dissipate within the aquarium 104. In one embodiment, the system controller 110 may cause the transducer 112 to emit only one harmonic frequency for a preset duration of time. In one embodiment, the system controller 110 may combine multiple harmonic frequencies via mathematical summation at a given time step, which may help increase the overall energy efficiency of the wave generator system 100 by reducing the power consumption of the transducer 112. In an example, the system controller 110 may combine the harmonic values, e.g., superimpose and/or modulate the current amplitudes of each harmonic into a single amplitude, and emitting the summated harmonic frequency.

In an alternative embodiment, the wave generator system 100 may directly apply the one or more harmonic frequencies to the aquarium 104, without utilizing a wave chamber. For example, in one embodiment, the wave generator system 100 may not include a wave chamber and may instead include a waterproof transducer 112 that is positioned within the aquarium 104 or directly adjacent to a sidewall of the aquarium 104. In example, a vertical sidewall of the aquarium 104 may have a cutout therein in which the transducer 112 is sealably mounted, underneath a waterline of the water within the aquarium 104. In another example, the transducer 112 may be attached to a vertical sidewall 136 in the aquarium 104 via a fastener or waterproof epoxy. In an alternative embodiment, the airwave can be applied via a waterproof diaphragm embedded within a vertical sidewall 136 of the aquarium 104, which is fluidly connected to a distally-located transducer via an air tube. In yet another example, the transducer 112 is mounted above the wave chamber and fluidly connected to the wave chamber without any hose.

Aspects of the invention cover devices, systems, and methods related to a wave generator system, including methods of use thereof. The method steps disclosed herein can be performed in a differing order as desired. The steps of the methods disclosed herein may be performed by the system controller.

Although limited embodiments of wave generator systems, and methods of operation thereof, have been specifically described and illustrated herein, many modifications and variations will be apparent to those skilled in the art. The disclosure is also defined in the following claims.

### Example Embodiments

The following are numbered example embodiments of the apparatuses, devices, systems, and methods related to a wave generator system. The below listing of examples or any other examples disclosed herein may be combined in whole or in part. Elements of the examples disclosed herein are not limiting.

Example 1. A wave generator system including a transducer configured to generate an airwave at a first harmonic frequency to form a corresponding water wave within an enclosed body of water.

Example 2. A wave generator system including a transducer configured to generate an airwave at a first harmonic frequency and a wave chamber fluidly coupled to the transducer. The wave chamber is configured to receive the airwave from the transducer and generate a water wave in an enclosed body of water.

Example 3. The assembly, system, device, apparatus, and method of any of the above Examples alone or in combination, wherein the wave generator further includes a wave chamber fluidly coupled to the transducer. The wave chamber is configured to be located within the enclosed body of water. The wave chamber is configured to receive the airwave and generate the water wave in the enclosed body of water.

Example 4. The assembly, system, device, apparatus, and method of any of the above Examples alone or in combination, wherein the enclosed body of water is an aquarium.

Example 5. The assembly, system, device, apparatus, and method of any of the above Examples alone or in combination, wherein the transducer is configured to generate and cycle multiple harmonic frequencies, including the first harmonic frequency, a second harmonic frequency, and a third harmonic frequency, which collectively form the water wave. In other examples, such as for a large aquarium, the transducer is configured to generate higher harmonics, such as six or higher, eight or higher, ten or higher, twenty or higher, and thirty or higher.

Example 6. The assembly, system, device, apparatus, and method of any of the above Examples alone or in combination, wherein the one or more harmonics, such as the first, the second, and the third harmonic frequency, are generated by the transducer in an alternating cycle such that the transducer alternates between the one or more harmonics.

Example 7. The assembly, system, device, apparatus, and method of any of the above Examples alone or in combination, wherein the wave generator system further includes a system controller operably connected to the transducer and configured to provide an electrical signal to the transducer. The transducer is configured to convert the electrical signal into the airwave.

Example 8. The assembly, system, device, apparatus, and method of any of the above Examples alone or in combination, wherein the wave generator system further includes an air tube sealably coupling the wave chamber to the transducer.

Example 9. The assembly, system, device, apparatus, and method of any of the above Examples alone or in combination, wherein the transducer is a diaphragm speaker that is configured to generate the airwave.

Example 10. The assembly, system, device, apparatus, and method of any of the above Examples alone or in combination, wherein the wave chamber is configured to be at least partially filled with water.

Example 11. The assembly, system, device, apparatus, and method of any of the above Examples alone or in combination, wherein the wave chamber is configured to generate an initial water wave, in the water located within the wave chamber, and thereafter expel the initial water wave toward a vertical wall of the enclosed body of water to generate the water wave within the enclosed body of water.

Example 12. The assembly, system, device, apparatus, and method of any of the above Examples alone or in combination, wherein the wave chamber further comprises an inlet fluidly connected to the transducer and configured to be located above a waterline of the water within the enclosed body of water.

Example 13. The assembly, system, device, apparatus, and method of any of the above Examples alone or in combination, wherein the wave chamber comprises an outlet that is configured to be located underneath the waterline of the water within the enclosed body of water.

Example 14. The assembly, system, device, apparatus, and method of any of the above Examples alone or in combination, wherein the wave chamber is configured to be connected to a vertical wall of the enclosed body of water. The wave chamber is configured to apply the water wave initially parallel to the vertical wall to which the wave chamber is connected.

Example 15. The assembly, system, device, apparatus, and method of any of the above Examples alone or in combination, wherein the wave chamber comprises a shell body.

Example 16. The assembly, system, device, apparatus, and method of any of the above Examples alone or in combination, wherein the shell body includes a top wall, a plurality of sidewalls extending from the top wall, and at least one angled bottom wall extending downwardly at an angle from at least one corresponding sidewall of the plurality of sidewalls.

Example 17. The assembly, system, device, apparatus, and method of any of the above Examples alone or in combination, wherein the top wall includes an inlet therein. The inlet is in the form an inlet aperture extending through the top wall.

Example 18. The assembly, system, device, apparatus, and method of any of the above Examples alone or in combination, wherein the at least one angled bottom wall includes an outlet therein. The outlet is in the form of an outlet aperture extending through the at least one angled bottom wall such that water flowing out of the outlet is configured to be directed downwardly and toward a wall of an enclosure of the enclosed body of water.

Example 19. The assembly, system, device, apparatus, and method of any of the above Examples alone or in combination, wherein the wave chamber is a first wave chamber configured to be connected to a first wall of the enclosed body of water.

Example 20. The assembly, system, device, apparatus, and method of any of the above Examples alone or in combination, wherein the wave generator system further includes a second wave chamber fluidly coupled to the transducer. The second wave chamber is configured to be connected to a second wall of the enclosed body of water, opposite the first wall.

Example 21. The assembly, system, device, apparatus, and method of any of the above Examples alone or in combination, wherein the wave generator system further includes at least one sensor configured to sense one or more characteristics of the water wave.

Example 22. The assembly, system, device, apparatus, and method of any of the above Examples alone or in combination, wherein the one or more characteristics of the water wave include a position of the water wave, a number of crests of the water wave, a number of troughs of the water wave, and a cycle of the water wave.

Example 23. An aquarium including an enclosure configured to hold water therein. The transducer is located outside of the enclosure and configured to generate an airwave at a first harmonic frequency. The wave generator system includes a wave chamber fluidly coupled to the transducer. The wave chamber is located within and connected to the enclosure. The wave chamber is configured to generate a water wave in the enclosure based at least in part upon the first harmonic frequency.

Example 24. A method including determining one or more harmonic frequencies of an enclosed body of water. The method also includes generating, by a transducer, an airwave based on the one or more harmonic frequencies. The method also includes generating, by a wave chamber fluidly coupled to the transducer, a water wave in the enclosed body of water, based at least in part upon the airwave.

Example 25. The assembly, system, device, apparatus, and method of any of the above Examples alone or in combination, wherein the method further includes monitoring, by a sensor operably coupled to the system controller, the water wave within the enclosed body of water to sense one or more wave characteristics of the water wave.

Example 26. The assembly, system, device, apparatus, and method of any of the above Examples alone or in combination, wherein the method further includes adjusting the airwave generated by the transducer, based upon the sensed one or more wave characteristics.

Example 27. A wave generator system for an aquarium comprising a transducer having a diaphragm located in a housing, a controller for operatively connected to the transducer for causing the diaphragm to oscillate, a wave chamber having a housing with an inlet and an outlet, and wherein a hose connects the transducer to the wave chamber to establish communication between the transducer and the wave chamber.

Example 26. The assembly, system, device, apparatus, and method of any of the above Examples alone or in combination, wherein the housing of the wave chamber has a hollow interior and the inlet is located at a top wall.

Example 27. The assembly, system, device, apparatus, and method of any of the above Examples alone or in combination, wherein the housing has an upper section of a first dimension and a lower section of a second dimension, which can optionally be smaller than the first dimension, and wherein the outlet is located at the lower section.

Example 28. The assembly, system, device, apparatus, and method of any of the above Examples alone or in combination, wherein the transducer comprises a housing having a port, and wherein the hose is coupled to the port.

Example 29. The assembly, system, device, apparatus, and method of any of the above Examples alone or in combination, wherein the housing of the wave chamber with the inlet has a port and wherein the hose is coupled to the port of the wave chamber.

Example 30. The assembly, system, device, apparatus, and method of any of the above Examples alone or in combination, wherein the housing of the wave chamber has a lower wall that is angled to a sidewall with the outlet.

Example 31. The assembly, system, device, apparatus, and method of any of the above Examples alone or in combination, wherein the housing of the wave chamber has a water service line and wherein the water service line is below an interior top wall of the housing.

Example 32. The assembly, system, device, apparatus, and method of any of the above Examples alone or in combination, wherein the housing of the wave chamber is formed from a plurality of wall panels that are bonded to one another.

Example 33. The assembly, system, device, apparatus, and method of any of the above Examples alone or in combination, wherein the wave generator system includes a wave chamber fluidly coupled to the transducer and the wave chamber is configured to generate a water wave in the enclosure based at least in part upon the first harmonic frequency to move water in the wave chamber predominantly vertically.

Example 34. The assembly, system, device, apparatus, and method of any of the above Examples alone or in combination, wherein the wave chamber and the transducer can be fluidly connected with or without a tubing.

Example 35. The assembly, system, device, apparatus, and method of any of the above Examples alone or in combination, wherein water wave in the aquarium is based at least in part upon one or more harmonic frequency moved in the wave chamber.

Example 36. The assembly, system, device, apparatus, and method of any of the above Examples alone or in combination, wherein the wave in the wave chamber is moved predominantly in a vertical direction, relative to a surface of the water column in the aquarium..

Example 37. The assembly, system, device, apparatus, and method of any of the above Examples alone or in combination, wherein the wave generator system comprises a transducer comprising a diaphragm, a driver, a magnet, a frame that holds the magnet, the driver, and the diaphragm.

Example 38. The assembly, system, device, apparatus, and method of any of the above Examples alone or in combination, wherein the frame is located in a housing and air pressure produced by the diaphragm is directed to a wave chamber.

What is claimed is:

1. A wave generator system comprising:
a transducer configured to generate an airwave at a first harmonic frequency to form a corresponding water wave within an enclosed body of water.

2. The wave generator system of claim 1, further comprising:
a wave chamber fluidly coupled to the transducer, the wave chamber is configured to be located within the enclosed body of water, and the wave chamber is configured to receive the airwave and generate the water wave in the enclosed body of water.

3. The wave generator system of claim 1, wherein the enclosed body of water is an aquarium.

4. The wave generator system of claim 1, wherein the transducer is configured to generate and cycle multiple harmonic frequencies, including the first harmonic frequency, a second harmonic frequency, and higher harmonic frequencies, which collectively form the water wave.

5. The wave generator system of claim 4, wherein the first, the second, and the higher harmonic frequencies are generated by the transducer in an alternating cycle such that the transducer alternates between the first, the second, and higher harmonic frequencies at a preset time interval.

6. The wave generator system of claim 1, further comprising:
a system controller operably connected to the transducer and configured to provide an electrical signal to the transducer; and
the transducer is configured to convert the electrical signal into the airwave.

7. The wave generator system of claim 1, further comprising an air tube sealably coupling the wave chamber to the transducer.

8. The wave generator system of claim 1, wherein the transducer is a diaphragm speaker that is configured to generate the airwave.

9. The wave generator system of claim 1, wherein the wave chamber is configured to be at least partially filled with water.

10. The wave generator system of claim 9, wherein the wave chamber is configured to generate an initial water wave in the water located within the wave chamber, and thereafter expel the initial water wave toward a vertical wall of the enclosed body of water to generate the water wave within the enclosed body of water.

11. The wave generator system of claim 1, wherein the wave chamber further comprises an inlet fluidly connected to the transducer and configured to be located above a waterline of the water within the enclosed body of water.

12. The wave generator system of claim 11, wherein the wave chamber comprises an outlet that is configured to be located underneath the waterline of the water within the enclosed body of water.

13. The wave generator system of claim 1, wherein the wave chamber is configured to be connected to a vertical wall of the enclosed body of water, and the wave chamber is configured to apply the water wave initially against, parallel to, or close to the vertical wall to which the wave chamber is connected.

14. The wave generator system of claim 1, wherein the wave chamber comprises:
a shell body including a top wall, a plurality of sidewalls extending from the top wall, and at least one angled bottom wall extending downwardly at an angle from at least one corresponding sidewall of the plurality of sidewalls;
the top wall includes an inlet therein, and the inlet is in the form an inlet aperture extending through the top wall; and
the at least one angled bottom wall includes an outlet therein, and the outlet is in the form of an outlet aperture extending through the at least one angled bottom wall such that water flowing out of the outlet is configured to be directed downwardly and toward a wall of an enclosure of the enclosed body of water.

15. The wave generator system of claim 1, wherein:
the wave chamber is a first wave chamber configured to be connected to a first wall of the enclosed body of water; and
the wave generator system further comprises a second wave chamber fluidly coupled to the transducer, and the second wave chamber is configured to be connected to a second wall of the enclosed body of water, opposite the first wall.

16. The wave generator system of claim 1, further comprising at least one sensor configured to sense one or more characteristics of the water wave.

17. The wave generator system of claim 16, wherein the one or more characteristics of the water wave include a position of the water wave, a number of crests of the water wave, a number of troughs of the water wave, and a cycle of the water wave.

18. An aquarium comprising:
an enclosure configured to hold water therein;
a transducer located outside of the enclosure and configured to generate an airwave at a first harmonic frequency; and
a wave chamber fluidly coupled to the transducer, the wave chamber located within and connected to the enclosure, and the wave chamber is configured to generate a water wave in the enclosure based at least in part upon the first harmonic frequency.

19. A method comprising:
determining one or more harmonic frequencies of an enclosed body of water;
generating, by a transducer, an airwave based on the one or more harmonic frequencies; and
generating, by a wave chamber fluidly coupled to the transducer, a water wave in the enclosed body of water, based at least in part upon the airwave.

20. The method of claim 19, further comprising:
monitoring, by a sensor operably coupled to the system controller, the water wave within the enclosed body of water to sense one or more wave characteristics of the water wave; and
adjusting the airwave generated by the transducer, based upon the sensed one or more wave characteristics.
